(19) United States
(12) Patent Application Publication
(10) Pub. No.: US 2021/0190052 A1
(43) Pub. Date: Jun. 24, 2021

(54) HIGH-PRESSURE PUMP CONFIGURATION

(71) Applicant: MICROFLUIDICS INTERNATIONAL CORPORATION, Westwood, MA (US)

(72) Inventors: Yang SU, Newton, MA (US); John Michael Bernard, Stoughton, MA (US); Marco Catalani, Burlington, MA (US); David Harney, Stoneham, MA (US); Jocemar Ramina, Lexington, MA (US); Michael Ratigan, Scituate, RI (US)

(73) Assignee: MICROFLUIDICS INTERNATIONAL CORPORATION, Westwood, MA (US)

(21) Appl. No.: 17/127,497

(22) Filed: Dec. 18, 2020

Related U.S. Application Data
(60) Provisional application No. 62/951,867, filed on Dec. 20, 2019.

(51) Int. Cl. F04B 19/04; F04B 53/14; F16J 15/3204

(52) U.S. Cl. CPC F04B 19/04; F16J 15/3204; F04B 53/14

(57) ABSTRACT

The present application provides new and innovative high-pressure fluid systems for preventing seal burning due to gas auto-ignition. The provided systems include an o-ring disposed within a seal cavity of a cup seal to decrease the dead volume in the seal cavity. By reducing the dead volume, the o-ring decreases the volume of gas that is able to accumulate and thus helps prevent the gas from auto-igniting as the gas is compressed. By preventing the gas from auto-igniting, the provided system helps prevent seal burning, which helps prevent premature cup seal failure and prevent fluid contamination.

### PRIORITY CLAIM

The present application claims priority to and the benefit of U.S. Provisional Application 62/951,867, filed Dec. 20, 2019, the entirety of which is herein incorporated by reference.

### TECHNICAL FIELD

The present application relates generally to high-pressure fluid systems. More specifically, the present application relates to preventing high-pressure seal burning due to gas auto-ignition.

### BACKGROUND

High-pressure fluid systems, such as high-pressure fluid mixers, high-pressure/high sheer fluid processors, high-pressure impinger jet reactors and high-pressure homogenizers, may make use of a high-pressure pump. These machines include various systems from Microfluidics International, a unit of Idex Corporation located in Westwood, Mass., such as lab/benchtop machines, pilot scale machines, and production scale machines. For example, the lab/benchtop machines may include the LM10, the LM20, the M110P, the LV1 Low Volume, M110Y, and HC 5000/8000 product offerings from Microfluidics International. The pilot scale machines may include, for example, the Pilot Scale M110EH and the Pilot Scale M815 product offerings from Microfluidics International. The production scale machines may include, for example, the M700 and M710 Series product offerings from Microfluidics International.

The pump includes a plunger that displaces a pressurized fluid within a channel. Once the fluid is displaced, it may be passed at extremely high pressure, e.g., through narrow microchannels, where the fluid is subject to high sheer, and/or into an impinging jet reactor. The pump system may include a high-pressure seal, such as a cup seal, that includes a seal cavity. The empty space within the seal cavity can be referred to as a seal cavity volume. Gas may accumulate in the seal cavity volume, and may become trapped as the plunger displaces the fluid. In some cases, gas may accumulate due to insufficient fluid priming and/or excessive entranced gas inside the fluid, for example. If a sufficient volume of gas accumulates in the seal cavity and is compressed under a sufficient amount of pressure, the gas may heat sufficiently to cause auto-ignition damage to the seal, e.g., burning of the seal.

Even though the same operating pressures may be obtained in lab, pilot, and large production volume machines, the above-described seal burning may be a greater concern in large production volume machines, where the amount of entranced or trapped gas is larger, resulting in greater potential for auto-ignition. When the gas auto-ignites it may burn various system parts near the auto-ignited gas, such as a seal used to prevent fluid leakage. Seal burning may have negative consequences. For instance, seal burning may cause contamination of the fluid being processed, which can be especially harmful in the case of preparing pharmaceutical or other high purity fluids. Seal burning may also cause the seal to fail prematurely. Low-pressure fluid systems typically do not create high enough pressure to cause the gas to auto-ignite. Accordingly, there exists a need for a high-pressure fluid system design that better prevents seal burning due to gas auto-ignition.

### SUMMARY

The present application provides new and innovative high-pressure fluid systems for preventing seal burning due to gas auto-ignition. The provided systems include an insert, such as an o-ring, disposed within a seal cavity of a cup seal to decrease the seal cavity volume. By reducing the seal cavity volume, the insert decreases the volume of gas that is able to accumulate and thus helps prevent the gas from auto-igniting as the gas is compressed. By preventing the gas from auto-igniting, the provided system helps prevent seal burning, which helps prevent premature cup seal failure and prevent fluid contamination.

In light of the disclosures herein, and without limiting the scope of the invention in any way, in a first aspect of the present application, which may be combined with any other aspect of the application listed herein unless specified otherwise, a high-pressure fluid system includes a pump body that includes a channel adapted to receive a fluid and a plunger. The channel is configured to include a lip at which an inner diameter of the channel increases. The system also includes a cup seal including a seal cavity. The cup seal is disposed at the lip of the channel. In this example, the system further includes an insert positioned within the seal cavity of the cup seal.

In a second aspect of the present application, which may be combined with any other aspect listed herein unless specified otherwise, the pump body is configured to withstand a fluid pressure equal to or greater than 5,000 psi.

In a third aspect of the present application, which may be combined with any other aspect listed herein unless specified otherwise, the pump body is configured to withstand a fluid pressure between 5,000 psi and 50,000 psi.

In a fourth aspect of the present application, which may be combined with any other aspect listed herein unless specified otherwise, the channel is constructed to include a ninety degree angle at the lip.

In a fifth aspect of the present application, which may be combined with any other aspect listed herein unless specified otherwise, the plunger includes an outer diameter between about 7/16 inches (1.11 cm) to about 3 inches (7.62 cm).

In a sixth aspect of the present application, which may be combined with any other aspect listed herein unless specified otherwise, the insert is an o-ring.

In a seventh aspect of the present application, which may be combined with any other aspect listed herein unless specified otherwise, the cup seal is constructed such that, without the insert positioned within the seal cavity, an empty volume of the seal cavity is equal to or greater than about 0.5 cubic inches (8.19 cubic cm).

In an eighth aspect of the present application, which may be combined with any other aspect listed herein unless specified otherwise, the cup seal and the insert are configured such that, with the insert positioned within the seal cavity, an empty volume of the seal cavity is insufficient for gas to accumulate in sufficient volume to auto-ignite.

In a ninth aspect of the present application, which may be combined with any other aspect listed herein unless specified otherwise, the cup seal and the insert are configured such that, with the insert positioned within the seal cavity, the empty volume of the seal cavity is equal to or less than 0.04 cubic inches (0.65 cubic cm).

In a tenth aspect of the present application, which may be combined with any other aspect listed herein unless specified otherwise, the channel has a diameter between about 7/16 inches (1.11 cm) to about 3 inches (7.62 cm), a fluid volume within the channel is between about 0.1 cubic inches (1.64 cubic cm) and 70 cubic inches (1,147 cubic cm), and with the insert positioned within the seal cavity, the empty volume of the seal cavity is equal to or less than 0.04 cubic inches (0.65 cubic cm).

In an eleventh aspect of the present application, which may be combined with any other aspect listed herein unless specified otherwise, the insert is constructed from an elastomer, a plastic, or a metal.

In a twelfth aspect of the present application, which may be combined with any other aspect listed herein unless specified otherwise, the insert is constructed from Nitrile, EPDM, Fluoroelastomers, Neoprene, Ultra-high-molecular-weight polyethylene (UHMWPE), polyether ether ketone (PEEK), Polytetrafluoroethylene, Perfluoroelastomer, or silicone, or a combination thereof.

In a thirteenth aspect of the present application, which may be combined with any other aspect listed herein unless specified otherwise, a high-pressure fluid system includes a pump body that includes a channel adapted to receive a fluid and a plunger. The channel is configured to include a lip at which an inner diameter of the channel increases. The system also includes a cup seal including a seal cavity. The cup seal is disposed at the lip of the channel and the pump body is configured to include a protrusion at the lip that extends into the cup seal's seal cavity.

In a fourteenth aspect of the present application, which may be combined with any other aspect listed herein unless specified otherwise, the protrusion is configured such that, with the protrusion extending into the seal cavity, the empty volume of the seal cavity is insufficient for gas to accumulate in sufficient volume to auto-ignite.

In a fifteenth aspect of the present application, which may be combined with any other aspect listed herein unless specified otherwise, the protrusion is configured such that, with the protrusion extending into the seal cavity the empty volume of the seal cavity is equal to or less than 0.04 cubic inches (0.65 cubic cm).

In a sixteenth aspect of the present application, which may be combined with any other aspect listed herein unless specified otherwise, the plunger has a diameter between about 7/16 inches (1.11 cm) to about 3 inches (7.62 cm), a fluid volume within the channel is between about 0.1 cubic inches (1.64 cubic cm) and 70 cubic inches (1,147 cubic cm), and with the insert positioned within the seal cavity, the empty volume of the seal cavity is equal to or less than 0.04 cubic inches (0.65 cubic cm).

In a seventeenth aspect of the present application, which may be combined with any other aspect listed herein unless specified otherwise, the pump body is configured to withstand a fluid pressure between 5,000 psi and 50,000 psi, and with the insert positioned within the seal cavity the empty volume of the seal cavity is equal to or less than 0.04 cubic inches (0.65 cubic cm).

### BRIEF DESCRIPTION OF THE DRAWINGS

FIG. 1A illustrates a cross-sectional view of a portion of a pump, according to an aspect of the present application.

FIG. 1B illustrates a cross-sectional view of a high-pressure fluid system, according to an aspect of the present application.

FIG. 2A illustrates a view of a cup seal looking into a seal cavity of the cup seal, according to an aspect of the present application.

FIG. 2B illustrates the cup seal of FIG. 2A including an insert disposed within the seal cavity, according to an aspect of the present application.

FIG. 2C illustrates a cross-sectional view of a seal configuration at the plane A-A illustrated in FIG. 2B, according to an aspect of the present application.

FIG. 3A is a photograph that illustrates a perspective view of a cup seal with a burn.

FIG. 3B is a photograph that illustrates a perspective view of a cup seal utilized with an insert that prevented gas auto-ignition from occurring.

FIG. 4 illustrates a cross-sectional view of a high-pressure fluid system, according to an aspect of the present disclosure.

### DETAILED DESCRIPTION

The present application provides new and innovative systems for preventing seal burning due to gas auto-ignition. The provided system may include a cup seal with a seal cavity, an insert within the seal cavity, and a pump channel lip, all of which contribute to reduce the critical compression ratio required for autoignition. The provided system minimizes the available space for gas to accumulate by including an insert within a seal cavity of a cup seal. For example, the insert may be an o-ring or another suitable component that fits within the seal cavity of a cup seal. Without the insert, the seal cavity volume is large enough to enable a sufficient gas volume to accumulate for auto-ignition. The insert helps to eliminate at least some of the seal cavity volume of the cup seal. For example, the insert may eliminate a majority of the seal cavity volume. While the provided system reduces the volume in the seal cavity of the system's cup seal as compared to typical systems' cup seal cavity volume, the provided system maintains the cup seal's performance. For instance, the provided system allows the cup seal to function (e.g., allows pressure to access the interior of the seal cavity of the seal cup) under a high pressure cycle. Minimizing the available space for gas to accumulate helps prevent compression ignition of the gas under high pressures and accordingly helps prevent the resulting seal burning. By helping prevent seal burning, the provided system helps prevent premature seal failure and helps prevent fluid contamination.

### First System Embodiment

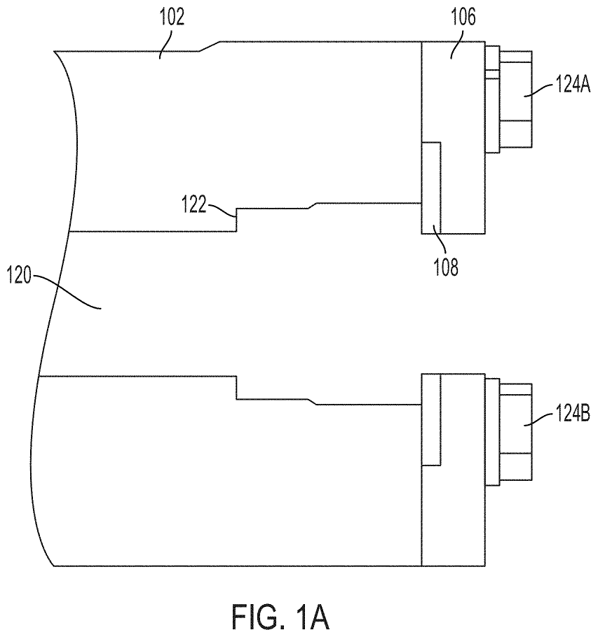

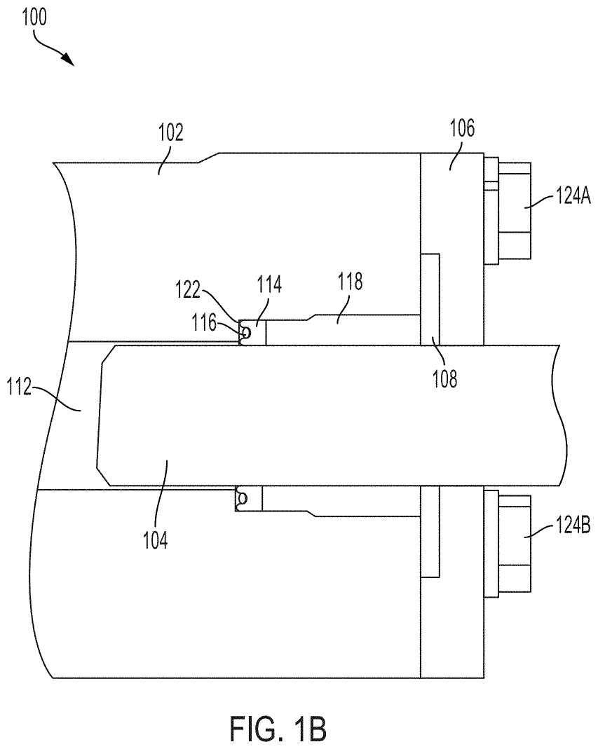

FIG. 1A illustrates a cross-sectional view of a portion of an example pump including an example pump body 102. The pump body 102 includes a channel 120 extending through at least a portion of the pump body 102. A portion of the channel 120 includes a diameter (e.g., between about 7/16 inches (1.11 cm) to about 3 inches (7.62 cm)) that substantially conforms to an outer diameter of a plunger (e.g., the plunger 104) while enabling the plunger 104 to translate with sufficient fluid between the plunger 104 and a wall of the channel 120.

The channel 120 includes a lip 122 at which the diameter of the channel 120 changes, as illustrated. For instance, at the lip 122, the diameter of the channel 120 increases from a diameter that substantially conforms to the plunger 104, as described above, to a larger diameter. The portion of the channel 120 having the larger diameter may be concentric with the portion of the channel 120 having the smaller diameter. The lip 122 may be configured at a 90-degree angle as illustrated, in some examples, to effect the increase in diameter within the channel 120. In other examples, the lip 122 may be configured at other suitable angles to effect the change in diameter of the channel 120.

In at least some aspects, a cap 106 may be secured to the pump body 102. For instance, one or more bolts 124A, 124B may secure the cap 106 to the pump body 102. In various aspects, a washer 108 may be positioned as illustrated between the cap 106 and the pump body 102.

FIG. 1B shows a cross-sectional view of an example high-pressure fluid system 100, e.g., a high-pressure intensifier pump, according to an aspect of the present application. The system 100 may include the pump body 102 and a plunger 104 within the channel 120 of the pump body 102. The plunger 104 may displace a fluid 112 within the channel 120. In some examples, the plunger 104 may have an outer diameter within a range of about ⅛ inches (0.318 cm) to about 6 inches (15.24 cm). In some examples, the plunger 104 may have an outer diameter within a range of about 7/16 inches (1.11 cm) to about 3 inches (7.62 cm). In other examples, the plunger 104 may have another suitable outer diameter.

The system 100 is configured such that the plunger 104 has a suitable stroke length to displace the fluid 112 within the channel 120. In some examples, the plunger 104 has a stroke length equal to a length within a range of about 2.5 inches (6.35 cm) to about 18 inches (45.72 cm). In some examples, the plunger 104 has a stroke length equal to a length within a range of about 2.5 inches (6.35 cm) to about 10 inches (25.4 cm). The system 100 may also include a bearing 118. It should be appreciated that only one side of each of the pump body 102, the cap 106, the washer 108, and the bearing 118 is indicated in the figure because the figure is a cross-sectional view, and that each component continues to the other side of the figure.

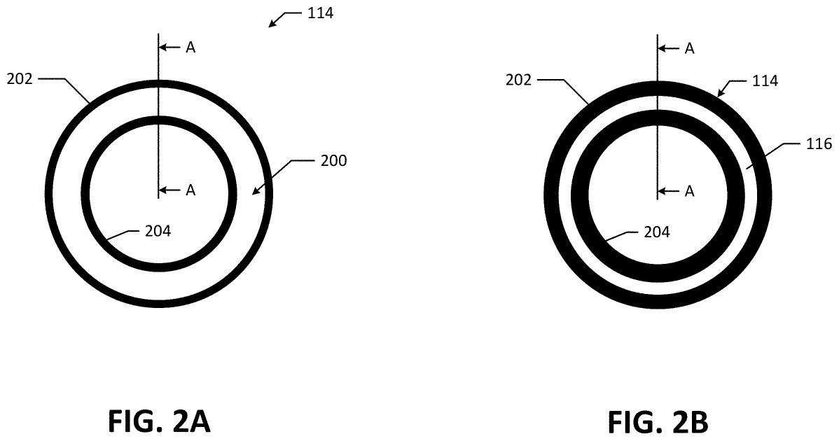

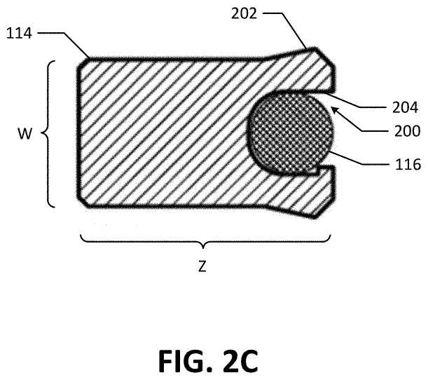

In various examples, the system 100 may also include an insert 116 disposed within a seal cavity 200 (FIG. 2A) of a cup seal 114. In such examples, the cup seal 114 and the insert 116 are located at the lip 122 of the channel 120 of the pump body 102. The insert 116 eliminates a portion of the volume of the seal cavity 200 of the cup seal 114, and thus eliminates volume for gas to accumulate.

For example, a one-inch (2.54 cm) diameter plunger 104 (and thus a slightly larger than one-inch (2.54 cm) diameter channel 120) having an eight-inch (20.32 cm) stroke corresponds to a fluid volume in the channel 120 of about 6.28 cubic inches (102.9 cubic cm). In this example, a cup seal 114 may be used such that without the insert 116, the empty volume of the seal cavity 200 in the cup seal 114 positioned in the channel 120 may be equal to about 0.5 cubic inches (8.19 cubic cm). The inventors have shown that an empty seal cavity 200 volume equal to or greater than about 0.5 cubic inches (8.19 cubic cm) for a typical high-pressure fluid system including a one-inch (2.54 cm) diameter plunger and correspondingly-sized cup seal 114 is sufficient for gas to accumulate to a volume that may cause the gas to auto-ignite. In contrast, the provided system 100 with the insert 116 positioned in the seal cavity 200 of the cup seal 114 decreases the empty seal cavity 200 volume. In at least one example, the insert 116 decreases the empty seal cavity 200 volume to 0.04 cubic inches (0.65 cubic cm). The inventors have shown that an empty seal cavity 200 volume equal to or less than 0.04 cubic inches (0.65 cubic cm) in an example of the provided system 100 including a one-inch (2.54 cm) diameter plunger and correspondingly-sized cup seal 114 prevents the gas from accumulating to a volume sufficient for the gas to auto-ignite. Accordingly, the system 100 having the insert 116 helps prevent auto-ignition.

It should be appreciated that the quantities in the above example are merely one example to demonstrate how the insert 116 of the provided system 100 reduces the empty seal cavity volume to help prevent auto-ignition. In other examples of the provided system 100, the plunger 104 may have other suitable diameters, which corresponds to a different correspondingly-sized cup seal 114 than the above example. A cup seal 114 of a different size may have a different empty seal cavity volume 200 with and without an insert. In any of these examples, however, the use of the insert 116 within the seal cavity 200 of the cup seal 114 reduces the empty seal cavity 200 volume to help prevent auto-ignition.

The system 100 may operate at high fluid pressures. For instance, the system 100 may operate at fluid pressures equal to or greater than 5,000 psi. Operating ranges may also include 10,000-40,000 psi, 20,000-40,000 psi, and 30,000-40,000 psi. In some examples, the system 100 may operate at fluid pressures equal to or greater than 40,000 psi, e.g., in an additional range of 40,000 to 50,000 psi.

FIG. 2A illustrates an example cup seal 114 at a view looking into a seal cavity 200 of the example cup seal 114. In at least some aspects, the cup seal 114 includes an outer wall 202 and an inner wall 204 that are integral with one another at one end of the cup seal 114. At the opposite end of the cup seal 114, the outer wall 202 and the inner wall are separate from one another thereby forming a seal cavity 200 within the cup seal 114. FIG. 2B illustrates the cup seal 114 of FIG. 2A having an insert 116 (e.g., an o-ring) disposed within the seal cavity 200. FIG. 2C illustrates a cross-sectional view of the cup seal 114 having the insert 116 disposed within its seal cavity 200 at the plane A-A illustrated in FIG. 2B.

In some aspects, the cup seal 114 may have a height W equal to a quantity within a range of about 0.1 inches (0.254 cm) to about 0.5 inches (1.27 cm). In an example, the cup seal 114 may have a height W equal to 0.25 inches (0.635 cm). In other aspects, the cup seal 114 may have another suitable height W. In some aspects, the cup seal 114 may have a width Z equal to a quantity within a range of about 0.187 inches (0.475 cm) to about 0.75 inches (1.91 cm). In some aspects, the cup seal 114 may have a width Z equal to a quantity within a range of about 0.187 inches (0.475 cm) to about 0.469 inches (1.19 cm). In other aspects, the cup seal 114 may have another suitable width Z.

The cup seal 114 may have a circular cross section as illustrated in FIGS. 2A and 2B, in various aspects. In such aspects, the cup seal 114 may have an inner diameter that is slightly larger than the outer diameter of the plunger 104 with which it is used, as will be appreciated by one of skill in the art. In such aspects, the insert 116 may also be circular and may have an inner and an outer diameter such that the insert 116 fits within the seal cavity 200 as shown in FIG. 2B. In other aspects, the cup seal 114 may have another suitable shape, such as square, octagon, decagon, etc. In such other aspects, the insert 116 may have a shape that corresponds to the shape of the cup seal 114.

In various aspects, the cup seal 114 and/or the insert 116 may be made from one or more of an elastomer or a plastic, such as Nitrile, EPDM, Fluoroelastomers—FKM (e.g., Viton®), Neoprene, ultra high weight molecular weight polyethylene (UHMWPE), polyether ether ketone (PEEK), Polytetrafluoroethylene—PTFE (e.g., Teflon®), Perfluoroelastomer—FFKM (e.g., Kalrez®), silicone, or other suitable elastomers or plastics. In other aspects, the cup seal and/or the insert 116 may be made from other suitable materials for high-pressure applications. For instance, in some aspects, the insert 116 may be made from a metal, such as steel, stainless steel, metal alloys, or other suitable metals. In some aspects, the insert 116 may be made from a combination of an elastomer, plastic, and/or a metal. In some aspects, the cup seal 114 and the insert 116 are made from the same material. In other aspects, the cup seal 114 and the insert 116 may be made from different materials.

### Example Validation of First System Embodiment

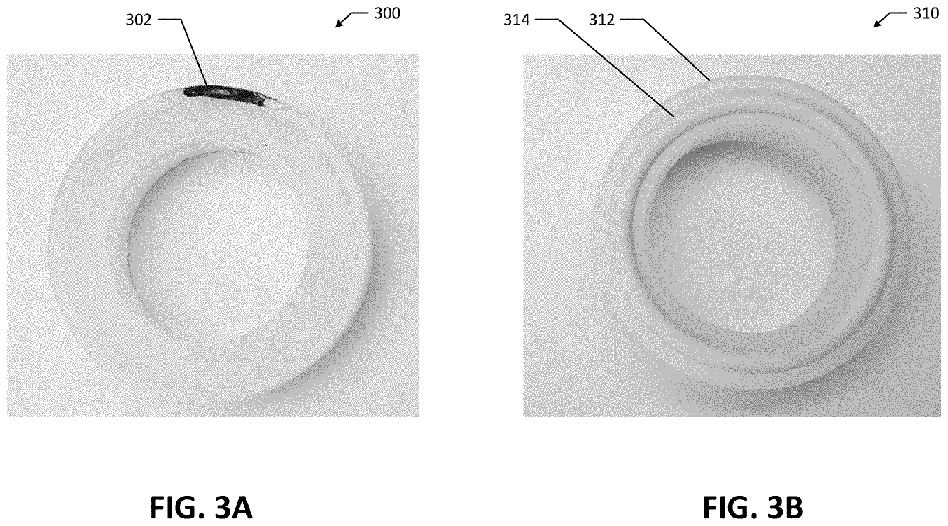

The inventors have demonstrated that a system configured as described above (e.g., the system 100) helps prevent auto-ignition that results in seal burning. To demonstrate this advantageous effect, a Microfluidics International M7250-30 high-pressure fluid processor machine was used at a fluid pressure of 30 kpsi with a cup seal constructed of high molecular weight polyethylene (UHMWPE). The machine was operated in two separate instances: (1) with a cup seal 300 (FIG. 3A) that did not have an insert and (2) with a cup seal 312 (FIG. 3B) having an o-ring 314 (FIG. 3B) as an insert. The o-ring 314 was constructed of Perfluoroelastomer—FFKM (e.g., Kalrez®).

FIG. 3A is a photograph illustrating a perspective view of the cup seal 300 after operation. As shown, the cup seal 300 includes a burn 302. The burn 302 was a result of auto-ignition of accumulated gas that occurred during operation of the machine. FIG. 3B is a photograph illustrating a perspective view of the cup seal 312 including an o-ring 314 disposed within a seal cavity of the cup seal 312 after operation of the machine. The cup seal 312 with the inserted o-ring 314 replaced the cup seal 300 in the machine and prevented gas in the system from auto-igniting. As shown, both the cup seal 312 and the o-ring 314 are free from burn damage. The inventors also tested an o-ring constructed of Polytetrafluoroethylene—PTFE (e.g., Teflon®) in place of the o-ring 314 and achieved similar results in that PTFE o-ring was also free from burn damage.

### Second System Embodiment

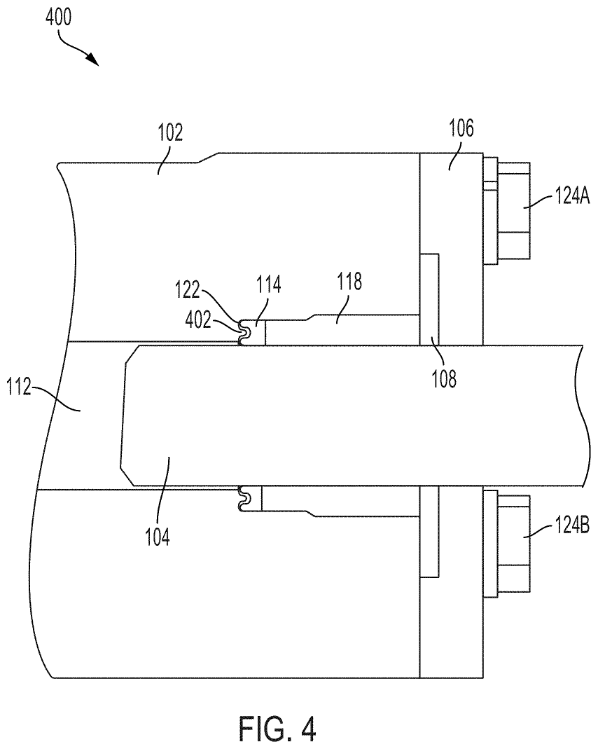

FIG. 4 shows a cross-sectional view of an example high-pressure fluid system 400, e.g., a high-pressure intensifier pump. The high-pressure fluid system 400 is an alternative embodiment of the present application to the high-pressure fluid system 100. In the high-pressure fluid system 400, the pump body 102 is configured to include a protrusion 402 extending outward from the pump body 102 at the lip 122. When a cup seal (e.g., the cup seal 114) is positioned at the lip, the protrusion 402 extends into the seal cavity 200 of the cup seal 114. In the example embodiment of the high-pressure fluid system 100, the protrusion 402 replaces the insert 116 used in the high-pressure fluid system 100 by reducing the empty seal cavity 200 volume in a similar manner as the insert 116 to prevent gas auto-ignition. It should also be appreciated that a gap is shown between the protrusion 402 and the cup seal 114 merely for the purpose of illustrating the two components, and that typically they are in contact with one another to decrease volume for gas accumulation.

As used herein, “about,” “approximately” and “substantially” are understood to refer to numbers in a range of numerals, for example the range of −10% to +10% of the referenced number, preferably −5% to +5% of the referenced number, more preferably −1% to +1% of the referenced number, most preferably −0.1% to +0.1% of the referenced number.

Without further elaboration, it is believed that one skilled in the art can use the preceding description to utilize the claimed inventions to their fullest extent. The examples and embodiments disclosed herein are to be construed as merely illustrative and not a limitation of the scope of the present application in any way. It will be apparent to those having skill in the art that changes may be made to the details of the above-described embodiments without departing from the underlying principles discussed. In other words, various modifications and improvements of the embodiments specifically disclosed in the description above are within the scope of the appended claims. For example, any suitable combination of features of the various embodiments described is contemplated.

The invention is claimed as follows:

1. A high-pressure fluid system comprising:
a pump body including a channel adapted to receive a fluid and a plunger, wherein the channel is configured to include a lip at which an inner diameter of the channel increases;
a cup seal including a seal cavity, wherein the cup seal is disposed at the lip of the channel; and
an insert positioned within the seal cavity of the cup seal.

2. The high-pressure fluid system of claim 1, wherein the pump body is configured to withstand a fluid pressure equal to or greater than 5,000 psi.

3. The high-pressure fluid system of claim 1, wherein the pump body is configured to withstand a fluid pressure between 5,000 psi and 50,000 psi.

4. The high-pressure fluid system of claim 1, wherein the channel is constructed to include a ninety degree angle at the lip.

5. The high-pressure fluid system of claim 1, wherein the plunger includes an outer diameter between about 7/16 inches (1.11 cm) to about 3 inches (7.62 cm).

6. The high-pressure fluid system of claim 1, wherein the insert is an o-ring.

7. The high-pressure fluid system of claim 1, wherein the cup seal is constructed such that, without the insert positioned within the seal cavity, an empty volume of the seal cavity is equal to or greater than about 0.5 cubic inches (8.19 cubic cm).

8. The high-pressure fluid system of claim 1, wherein the cup seal and the insert are configured such that, with the insert positioned within the seal cavity, an empty volume of the seal cavity is insufficient for gas to accumulate in sufficient volume to auto-ignite.

9. The high-pressure fluid system of claim 1, wherein with the insert positioned within the seal cavity the empty volume of the seal cavity is equal to or less than 0.04 cubic inches (0.65 cubic cm).

10. The high-pressure fluid system of claim 1, wherein the channel has a diameter between about 7/16 inches (1.11 cm) to about 3 inches (7.62 cm), wherein a fluid volume within the channel is between about 0.1 cubic inches (1.64 cubic cm) and 70 cubic inches (1,147 cubic cm), and wherein with the insert positioned within the seal cavity the empty volume of the seal cavity is equal to or less than 0.04 cubic inches (0.65 cubic cm).

11. The high-pressure fluid system of claim 1, wherein the insert is constructed from an elastomer, a plastic, or a metal.

12. The high-pressure fluid system of claim 11, wherein the insert is constructed from Nitrile, EPDM, Fluoroelastomers, Neoprene, Ultra-high-molecular-weight polyethylene (UHMWPE), polyether ether ketone (PEEK), Polytetrafluoroethylene, Perfluoroelastomer, or silicone, or a combination thereof.

13. A high-pressure fluid system comprising:
a pump body including a channel adapted to receive a fluid and a plunger, wherein the channel is configured to include a lip at which an inner diameter of the channel increases; and
a cup seal including a seal cavity, wherein the cup seal is disposed at the lip of the channel,
wherein the pump body is configured to include a protrusion at the lip that extends into the seal cavity.

14. The high-pressure fluid system of claim 13, wherein the pump body is configured to withstand a fluid pressure equal to or greater than 5,000 psi.

15. The high-pressure fluid system of claim 13, wherein the pump body is configured to withstand a fluid pressure between 5,000 psi and 50,000 psi.

16. The high-pressure fluid system of claim 13, wherein the protrusion is configured such that, with the protrusion extending into the seal cavity, the empty volume of the seal cavity is insufficient for gas to accumulate in sufficient volume to auto-ignite.

17. The high-pressure fluid system of claim 13, wherein with the protrusion extending into the seal cavity the empty volume of the seal cavity is equal to or less than 0.04 cubic inches (0.65 cubic cm).

18. The high-pressure fluid system of claim 13, wherein the plunger includes an outer diameter between about 7/16 inches (1.11 cm) to about 3 inches (7.62 cm), wherein a fluid volume within the channel is between about 0.1 cubic inches (1.64 cubic cm) and 70 cubic inches (1,147 cubic cm), and wherein with the insert positioned within the seal cavity the empty volume of the seal cavity is equal to or less than 0.04 cubic inches (0.65 cubic cm).

19. The high-pressure fluid system of claim 13, wherein the channel is constructed to include a ninety degree angle at the lip.

20. The high-pressure fluid system of claim 13, wherein the pump body is configured to withstand a fluid pressure between 5,000 psi and 50,000 psi, and wherein with the insert positioned within the seal cavity the empty volume of the seal cavity is equal to or less than 0.04 cubic inches (0.65 cubic cm).
